(19) United States
(12) Patent Application Publication
(10) Pub. No.: US 2013/0059201 A1
(43) Pub. Date: Mar. 7, 2013

(54) NEGATIVE-ELECTRODE ACTIVE SUBSTANCE FOR ELECTRICITY STORAGE DEVICE, AND NEGATIVE ELECTRODE MATERIAL FOR ELECTRICITY STORAGE DEVICE AND NEGATIVE ELECTRODE FOR ELECTRICITY STORAGE DEVICE WHICH USE THE SAME

(71) Applicants: Hideo Yamauchi, Otsu-shi (JP); Tomohiro Nagakane, Otsu-shi (JP); Akihiko Sakamoto, Otsu-shi (JP); Tetsuo Sakai, Ikeda-shi (JP); Meijing Zou, Ikeda-shi (JP)

(72) Inventors: Hideo Yamauchi, Otsu-shi (JP); Tomohiro Nagakane, Otsu-shi (JP); Akihiko Sakamoto, Otsu-shi (JP); Tetsuo Sakai, Ikeda-shi (JP); Meijing Zou, Ikeda-shi (JP)

(21) Appl. No.: 13/696,678

(22) PCT Filed: Apr. 18, 2011
(86) PCT No.: PCT/JP2011/059549

§ 371 Date: Nov. 7, 2012

(30) Foreign Application Priority Data
May 12, 2010 (JP) 2010-110404

(51) Int. Cl. H01M 4/48; H01M 4/46; H01B 1/02; H01G 9/155; H01G 9/15; H01B 1/04; H01M 4/38; H01G 9/042

(52) U.S. Cl. 429/211; 361/532; 361/502; 252/182.1; 252/502; 252/500; 252/512

(57) ABSTRACT

Provided is a negative-electrode active material for an electricity storage device, comprising: at least one kind of inorganic material selected from Si, Sn, Al, an alloy comprising any one of Si, Sn, and Al, and graphite; and an oxide material comprising at least one of P₂O₅ and B₂O₃.

TECHNICAL FIELD

The present invention relates to a negative-electrode active material suitable for an electricity storage device used for portable electronic devices, electric vehicles, electric tools, emergency backup power supplies, and the like.

### BACKGROUND ART

In recent years, owing to widespread use of portable personal computers and portable phones, it has been highly demanded to develop an electricity storage device such as a lithium ion secondary battery having a higher capacity and a reduced size. When an electricity storage device has a higher capacity, reduction in size of a device can be facilitated, and hence the development of an electrode material for an electricity storage device is urgently needed in order to accomplish the higher capacity.

For example, high potential type materials such as LiCoO₂, LiCo₁₋ₓNiₓO₂, LiNiO₂, and LiMn₂O₄ are each widely used for a positive electrode material for a lithium ion secondary battery, and on the other hand, a carbonaceous material is generally used for a negative electrode material. These materials function as electrode active materials that reversibly store and release lithium ions through charge and discharge, and constitute a so-called rocking chair type secondary battery in which both electrodes are electrochemically connected through a non-aqueous electrolytic solution or a solid electrolyte.

Examples of the carbonaceous material used as a negative electrode material include a graphite carbon material, pitch coke, fibrous carbon, and high-capacity type soft carbon prepared by low-temperature firing. However, the carbonaceous material has a relatively small lithium insertion capacity, and hence involves a problem in that the carbonaceous material has a low capacity. Specifically, even if a lithium insertion capacity in terms of stoichiometric amount is attained, the upper limit of the capacity of the carbon material is about 372 mAh/g.

In view of the foregoing, there is proposed a negative electrode material comprising Si or Sn as a negative electrode material that is capable of storing and releasing lithium ions and has a higher capacity density than the negative electrode material comprising the carbonaceous material (see, for example, Non Patent Literature 1).

### CITATION LIST

### Non Patent Literature

Non Patent Literature 1: M. Winter, J. O. Besenhard, Electrochimica Acta, 45(1999), p.31

### SUMMARY OF INVENTION

### Technical Problem

A negative electrode material comprising Si or Sn is excellent in initial charge-discharge efficiency (ratio of an initial discharge capacity to an initial charge capacity), but has a remarkably large volume change due to the storage and release reactions of lithium ions during charge and discharge. As a result, repeated charge and discharge causes degradation of the structure of the negative electrode material, and hence a crack is liable to be generated. If the crack develops, a void is formed in the negative electrode material in some cases, and the negative electrode material may be turned into fine powder. When a crack is generated in the negative electrode material, an electron-conducting network is divided, which results in a problem of a reduction in discharge capacity after repeated charge and discharge (cycle performance).

Thus, the present invention has been made in view of the circumstances described above, and has an object to provide a negative-electrode active material for an electricity storage device, which has a high capacity and a satisfactory initial charge-discharge performance and also is excellent in cycle performance, and a negative electrode material for an electricity storage device and a negative electrode for an electricity storage device each of which uses such the negative-electrode active material.

### Solution to Problem

The inventors of the present invention have made various studies. As a result, the inventors have found that the problem can be solved by using a negative-electrode active material for an electricity storage device produced by mixing a particular oxide, which is capable of abating volume expansion during charge and discharge, with a conventional negative electrode material comprising Si or Sn, and propose the finding as the present invention.

That is, the present invention presents a negative-electrode active material for an electricity storage device, comprising at least one kind of inorganic material selected from Si, Sn, Al, an alloy comprising any one of Si, Sn, and Al, and graphite, and an oxide material comprising at least one of P₂O₅ and B₂O₃.

It is known that, in at least one kind of negative-electrode active material selected from Si, Sn, Al, an alloy comprising any one of them, and graphite, which is able to store and release Li ions and electrons, the following reaction takes place during charge and discharge.

M+zLi⁺+ze⁻ [symbol] Li_{z}M (1)

(M represents at least one material selected from Si, Sn, Al, an alloy comprising any one of them, and graphite.)

Here, the at least one kind of negative-electrode active material selected from Si, Sn, Al, an alloy comprising any one of them, and graphite has a large storing amount of Li ions, and hence involves remarkable volume expansion when an Li_{z}M alloy is formed during charge. When metal Sn, for example, is used as a negative-electrode active material, Sn stores 4.4 Li ions and electrons from a positive electrode during charge, and the volume expansion thereof becomes about 3.52 times. Thus, if the negative-electrode active material is used alone, when charge and discharge is repeated, a crack is liable to be generated in the negative electrode material, causing a deterioration in cycle performance.

In the present invention, the above-mentioned negative-electrode active material is complexed with an oxide material comprising at least one of P₂O₅ and B₂O₃. Thus, at least one kind of inorganic material selected from Si, Sn, Al, an alloy comprising any one of them, and graphite is present in the state of being covered by an oxide material structured with a phosphate network and/or a borate network, and hence the volume change of the negative-electrode active material, which comprises the inorganic material, during charge and discharge can be abated by the oxide material structured with the phosphate network and/or the borate network. Further, Li ions having a small ion radius and a positive electric field are stored in the phosphate network and/or the borate network, thereby the shrinkage of each network occurs, resulting a reduction in molar volume. That is, the phosphate network and/or the borate network not only have the function of abating the volume increase of the negative-electrode active material, which comprises the inorganic material, during charge and discharge, but also have the function of suppressing the increase. Thus, even when charge and discharge is repeated, a crack in the negative electrode material due to the volume change can be suppressed, and hence the cycle performance can be prevented from deteriorating.

Second, in the negative-electrode active material for an electricity storage device of the present invention, the oxide material may further comprise SnO.

SnO can store and release lithium ions and acts as a negative-electrode active material having a higher capacity density than a carbon-based material. It is known that, when a negative-electrode active material comprising SnO is used, the following reaction takes place in the negative electrode during charge and discharge.

Sn^{x+}xe⁻→Sn (0)

Sn+yLi⁺+ye⁻ [symbol] Li_{y}Sn (1′)

First, at the time of initial charge, an irreversible reaction in which Sn^{x+} ion receives an electron, generating metal Sn, takes place (formula (0)). Subsequently, there occurs a reaction in which the generated metal Sn is bound to Li ion that has transferred from the positive electrode through an electrolytic solution and an electron supplied from a circuit, forming Sn—Li alloy (Li_{y}Sn). The reaction occurs as a reversible reaction in which a reaction proceeds in the right direction during charge and a reaction proceeds in the left direction during discharge (formula (1′)). Thereafter, the charge-discharge reaction of the formula (1′) is repeated.

Here, the charge-discharge reaction of the formula (1′) involves a large volume change. However, in a negative-electrode active material comprising SnO and an oxide material comprising P₂O₅ and/or B₂O₃, Sn^{x+} ions in the oxide are present in the state of being covered by a phosphate network and/or a borate network, and hence the volume change of Sn atom due to charge and discharge can be abated by the phosphate network and/or the borate network.

Note that in a negative-electrode active material comprising SnO, the reaction of the formula (0) requires extra electrons during initial charge, resulting in the reduction of initial charge-discharge efficiency. On the other hand, at least one kind of negative-electrode active material selected from Si, Sn, Al, an alloy comprising anyone of them, and graphite is excellent in initial charge-discharge efficiency, because such irreversible reaction as represented by the formula (0) is not necessary during charge and discharge, and hence such the negative-electrode active material compensates the reduction of the initial charge-discharge efficiency in the negative-electrode active material comprising SnO. That is, a negative-electrode active material produced by combining at least one kind of inorganic material selected from Si, Sn, Al, an alloy comprising any one of them, and graphite with an oxide material comprising SnO and P₂O₅ and/or B₂O₃ is characterized by having a high capacity, having an excellent cycle performance, and being excellent in initial charge-discharge efficiency.

Third, in the negative-electrode active material for an electricity storage device of the present invention, the oxide material may comprise, as a composition in terms of mol %, 45 to 95% of SnO and 5 to 55% of P₂O₅.

Fourth, in the negative-electrode active material for an electricity storage device of the present invention, the oxide material may be substantially amorphous.

According to such construction, the volume change due to storage and release of lithium ions becomes easy to be abated, and hence there is easily provided a high capacity electricity storage device which has an excellent initial charge-discharge efficiency and charge-discharge cycle performance. Note that the phrase “be substantially amorphous” means that no crystalline diffraction line is detected in powder X-ray diffraction measurement using CuK α-rays, and more specifically, means that a crystallinity is 0.1% or less.

Fifth, in the negative-electrode active material for an electricity storage device of the present invention, the content of the inorganic material may be 5 to 90% and the content of the oxide material may be 10 to 95% in terms of mass %.

Sixth, the present invention also presents a negative electrode material for an electricity storage device, comprising anyone of the above-mentioned negative-electrode active materials for an electricity storage device, a conductive agent, and a binder.

The conductive agent forms an electron-conducting network in the negative electrode material, enabling the negative electrode material to have a higher capacity and a higher rate. Further, the binder has the function of binding the materials constituting a negative electrode to each other, and prevents the negative-electrode active material from being detached from the negative electrode due to the volume change of the negative-electrode active material during charge and discharge.

Seventh, in the negative electrode material for an electricity storage device of the present invention, the content of the negative-electrode active material may be 55 to 90%, the content of the binder may be 5 to 30%, and the content of the conductive agent may be 3 to 20% in terms of mass %.

Eighth, the present invention also presents a negative electrode for an electricity storage device, comprising a current collector having a surface coated with any one of the above-mentioned negative electrode materials for an electricity storage device.

### DESCRIPTION OF EMBODIMENTS

A negative-electrode active material for an electricity storage device of the present invention comprises at least one kind of inorganic material selected from Si, Sn, Al, an alloy comprising any one of them, and graphite, and an oxide material comprising at least one of P₂O₅ and B₂O₃.

The inorganic material to be used in the present invention is at least one member selected from Si, Sn, Al, an alloy comprising any one of them (such as an Sn—Cu alloy), and graphite. Of those, preferred is Si, Sn, or Al, each of which has a large storing amount of Li ions, thus having a high capacity, or an alloy comprising any one of them, and particularly preferred is Si, which has the highest theoretical capacity.

When the inorganic material is in a powder form, the inorganic material has an average particle diameter of preferably 0.01 to 30 μm, 0.05 to 20 μm, 0.1 to 10 μm. If an inorganic material has an average particle diameter of more than 30 μm, the resultant negative electrode material is liable to be detached from a current collector because of volume change due to the storage and release of Li ions during charge and discharge. As a result, repeated charge and discharge tends to result in a remarkable reduction in capacity. On the other hand, if an inorganic material has an average particle diameter of less than 0.01 μm, it is difficult to mix the inorganic material homogeneously with an oxide comprising at least one of P₂O₅ and B₂O₃, and hence it tends to be difficult to manufacture a homogeneous electrode. In addition, the inorganic material has a larger specific surface area, and hence, when a paste for forming an electrode comprising powder of the inorganic material together with, for example, a binder and a solvent is manufactured, the dispersed state of the powder is so poor that the additive amount of the binder and solvent need to be increased, and that the paste has poor coatability, with the result that it tends to be difficult to form a homogeneous electrode.

The maximum particle diameter of the inorganic material is preferably 200 μm or less, 150 μm or less, 100 μm or less, 50 μm or less. If an inorganic material having a maximum particle diameter of more than 200 μm, the resultant negative electrode material is liable to be detached from a current collector because of a remarkably large volume change due to the storage and release of Li ions during charge and discharge. Further, particles of the inorganic material are liable to have cracks due to repeated charge and discharge. Consequently, the particles turn into finer particles and an electron-conducting network in the electrode material is liable to be divided. As a result, repeated charge and discharge tends to result in a remarkable reduction in capacity.

Note that in the present invention, the average particle diameter and the maximum particle diameter denote D50 (particle diameter at 50% in the volume cumulative distribution) and D100 (particle diameter at 100% in the volume cumulative distribution), respectively, in the median diameter of primary particles, and refer to values obtained by measurement with a laser diffraction particle size analyzer.

Examples of the oxide material comprising at least one of P₂O₅ and B₂O₃ include an oxide comprising only at least one of these components, a mixture of oxides containing these components, or an oxide material such as glass. Particularly in view of the foregoing reasons, an oxide material further comprising SnO in addition to P₂O₅ and/or B₂O₃ is preferred.

As an example of the oxide material, there is given one comprising, as a composition in terms of mol%, 45 to 95% of SnO and 5 to 55% of P₂O₅. The reasons for the limitation of the composition range are described below.

SnO is an active material component serving as a site for storing and releasing Li ions. The content of SnO is preferably 45 to 95%, 50 to 90%, 55 to 87%, 60 to 85%, 68 to 83%, particularly preferably 71 to 82%. When the content of SnO is less than 45%, the charge-discharge capacity per unit mass of the oxide material becomes smaller, with the result that the charge-discharge capacity of the negative-electrode active material also becomes smaller. Further, the content of P₂O₅ becomes relatively larger, which tends to deteriorate weather resistance remarkably. When the content of SnO is more than 95%, the amount of amorphous components in the oxide becomes smaller, so that the volume change due to the storage and release of Li ions during charge and discharge cannot be abated, and consequently, a sharp reduction in discharge capacity may occur. Note that the content of SnO component in the present invention refers to a total content of SnO and tin oxide components other than SnO (such as SnO₂) , provided that the contents of the tin oxide components are converted in terms of SnO.

P₂O₅ is a network-forming oxide, covers a site of SnO for storing and releasing Li ions, and functions as a solid electrolyte in which Li ions are movable. The content of P₂O₅ is preferably 5 to 55%, 10 to 50%, 13 to 45%, 15 to 40%, 17 to 32%, particularly preferably 18 to 29%. When the content of P₂O₅ is less than 5%, the volume change of SnO due to the storage and release of Li ions during charge and discharge cannot be abated, resulting in structural degradation, and hence the discharge capacity is liable to reduce during repeated charge and discharge. On the other hand, when the content of P₂O₅ is more than 55%, a stable crystal (such as SnP₂O₇) is easily formed together with an Sn atom, and there is brought about such a state that the influence of coordination bonds of lone pairs of electrons owned by each oxygen atom in chain P₂O₅ on an Sn atom is stronger. As a result, many electrons are necessary for reducing Sn ions in the formula (0), and hence the initial charge-discharge efficiency tends to lower.

Note that SnO/P₂O₅ (molar ratio) is preferably 0.8 to 19, 1 to 18, particularly preferably 1.2 to 17. When the SnO/P₂O₅ is less than 0.8, the Sn atom in SnO is liable to be influenced by the coordination of P₂O₅. As a result, the initial charge efficiency tends to lower. On the other hand, when the SnO/P₂O₅ is more than 19, the discharge capacity is liable to lower during repeated charge and discharge. This is probably because P₂O₅ coordinating to SnO decreases in the oxide, P₂O₅ cannot sufficiently cover SnO, and consequently, the volume change of SnO due to the storage and release of Li ions cannot be abated, causing structural degradation.

Further, as another example of the oxide material, there is given one comprising, as a composition in terms of mol %, 10 to 85% of SnO, 3 to 90% of B₂O₃, and 0 to 55% of P₂O₅ (provided that the total content of B₂O₃+P₂O₅ is 15% or more) . The reasons for the limitation of the composition range are described below.

SnO is an active material component serving as a site for storing and releasing Li ions. The content of SnO is preferably 10 to 85%, 30 to 83%, 40 to 80%, particularly preferably 50 to 75%. When the content of SnO is less than 10%, the charge-discharge capacity per unit mass of the oxide material becomes smaller. As a result, the charge-discharge capacity of the resulting negative-electrode active material also becomes smaller. On the other hand, when the content of SnO is more than 85%, the amount of amorphous components in the oxide material becomes smaller, and hence the volume change due to the storage and release of Li ions during charge and discharge cannot be abated. Consequently, the discharge capacity of the resulting negative-electrode active material may sharply reduce.

B₂O₃ is a network-forming oxide, covers a site of SnO for storing and releasing Li ions, abates the volume change due to the storage and release of Li ions during charge and discharge, and serves to maintain the structure of the oxide material. The content of B₂O₃ is preferably 3 to 90%, 5 to 70%, 7 to 60%, particularly preferably 9 to 55%. When the content of B₂O₃ is less than 3%, the volume change of SnO due to the storage and release of Li ions during charge and discharge cannot be abated, resulting in structural degradation, and hence the discharge capacity is liable to lower during repeated charge and discharge. On the other hand, when the content of B₂O₃ is more than 90%, there is brought about such a state that the influence of coordination bonds of lone pairs of electrons owned by each oxygen atom existing in a borate network on Sn atom is stronger. As a result, many electrons are necessary for reducing Sn ions in the formula (0), and hence initial charge-discharge efficiency tends to deteriorate. Further, the content of SnO becomes relatively smaller, the charge-discharge capacity per unit mass of the oxide material becomes smaller, and consequently, the charge-discharge capacity of the resulting negative-electrode active material tends to become smaller as well.

As described previously, P₂O₅ is a network-forming oxide, and forms a complex network by being intertwined with a borate network in a three-dimensional manner, thereby being able to cover a site of SnO for storing and releasing Li ions, abating the volume change due to the storage and release of Li ions during charge and discharge, and serving to maintain the structure of the oxide material. The content of P₂O₅ is preferably 0 to 55%, 5 to 50%, particularly preferably 10 to 45%. When the content of P₂O₅ is more than 55%, there is brought about such a state that the influence of coordination bonds of lone pairs of electrons owned by each oxygen atom existing in a phosphate network and a borate network on Sn atom is stronger. As a result, many electrons are necessary for reducing Sn ions in the formula (0), and hence initial charge-discharge efficiency tends to deteriorate. Further, the content of SnO becomes relatively smaller, the charge-discharge capacity per unit mass of the oxide material becomes smaller, and consequently, the charge-discharge capacity of the resultant negative-electrode active material tends to become smaller as well.

Note that the total content of B₂O₃ and P₂O₅ is preferably 15% or more, 20% or more, particularly preferably 30% or more. When the total content of B₂O₃ and P₂O₅ is less than 15%, the volume change of SnO due to the storage and release of Li ions during charge and discharge cannot be abated, resulting in structural degradation, and hence the discharge capacity is liable to lower during repeated charge and discharge.

Besides, various components can be further added to the oxide material in addition to the above-mentioned components in order to facilitate vitrification. For example, CuO, ZnO, MgO, CaO, Al₂O₃, SiO₂, and R₂O (R represents Li, Na, K, or Cs) can be contained at a total content of 0 to 20%, 0 to 10%, particularly 0.1 to 7%. When the total content of these components is more than 20%, the structure of the material is liable to be disordered and an amorphous material can be easily obtained, while a phosphate network or a borate network is liable to be cut. As a result, the volume change of the negative-electrode active material due to charge and discharge cannot be abated, possibly resulting in the deterioration of the cycle performance.

The oxide material in the present invention has a crystallinity of preferably 95% or less, 80% or less, 70% or less, 50% or less, particularly preferably 30% or less, and is most preferably substantially amorphous. In an oxide material comprising SnO at a high ratio, the smaller crystallinity is (the larger a ratio of amorphous phase is), the more the volume change during repeated charge and discharge is abated, which is advantageous in view of suppressing a reduction in discharge capacity.

The crystallinity is determined by performing peak separation to each crystalline diffraction line and an amorphous halo in a diffraction line profile ranging from 10 to 60° in terms of the 2θ value obtained by powder X-ray diffraction measurement using Cu Kα-rays. Specifically, when an integral intensity obtained by performing the peak separation of a broad diffraction line (amorphous halo) in the range of 10 to 45° from a total scattering curve obtained by performing background subtraction from the diffraction line profile is defined as Ia, and the total sum of integral intensities obtained by performing the peak separation of each crystalline diffraction line detected in the range of 10 to 60° from the total scattering curve is defined as Ic, the crystallinity Xc can be calculated on the basis of the following equation.

Xc=[Ic/(Ic+Ia)]x100 (%)

The oxide material in the present invention may comprise a phase formed of a complex oxide of a metal and an oxide or an alloy phase of a metal and another metal.

When the oxide material is in a powder form, the oxide material has preferably the average particle diameter of 0.1 to 10 μm and the maximum particle diameter of 75 μm or less, the average particle diameter of 0.3 to 9 μm and the maximum particle diameter of 65 μm or less, the average particle diameter of 0.5 to 8 μm and the maximum particle diameter of 55 μm or less, particularly preferably the average particle diameter of 1 to 5 μm and the maximum particle diameter of 45 μm or less. If the oxide material has the average particle diameter of more than 10 μm or the maximum particle diameter of more than 75 μm, when the oxide material is complexed with an inorganic material in a powder form, it is difficult to uniformly cover particles of the inorganic material with the oxide material therebetween, and the resultant negative electrode material is liable to be detached from a current collector because the volume change of the inorganic material due to the storage and release of Li ions during charge and discharge cannot be abated. As a result, repeated charge and discharge tends to cause the capacity to be remarkably reduced. On the other hand, if the oxide material has the average particle diameter less than 0.1 μm, when being formed into a paste, the oxide material becomes poor in dispersibility, and hence it tends to be difficult to manufacture a homogeneous electrode.

Further, the specific surface area of the oxide material in a powder form measured by the BET method is preferably 0.1 to 20 m²/g or 0.15 to 15 m²/g, particularly preferably 0.2 to 10 m²/g. If the oxide material has a specific surface area of less than 0.1 m²/g, the storage and release of Li ions cannot be performed rapidly and hence charge and discharge times tend to be longer. On the other hand, if the oxide material has a specific surface area of more than 20 m²/g, when a paste for forming an electrode comprising powder of the oxide material together with, for example, a binder and a solvent is manufactured, the dispersed state of the powder is so poor that the additive amount of the binder and solvent need to be increased, and that the paste has poor coatability, with the result that it tends to be difficult to form a homogeneous electrode.

Further, the tap density of the oxide material in a powder form is preferably 0.5 to 2.5 g/cm³, particularly preferably 1.0 to 2.0 g/cm³. If the powder has a tap density of less than 0.5 g/cm³, the filling amount per electrode unit volume of the negative electrode material is small, electrode density is thus poor, and hence it becomes difficult to attain a high capacity. On the other hand, if the oxide material has a tap density of more than 2.5 g/cm³, the filling state of the negative electrode material is too high for an electrolytic solution to penetrate easily, and consequently, a sufficient capacity may not be provided.

Note that the tap density herein refers to a value obtained by measurement under the conditions of a tapping stroke of 18 mm, a number of taps of 180, and a tapping rate of 1 tap/second.

In order to obtain powder having predetermined sizes, a general grinding mill or classifier is used. There is used, for example, a mortar, a ball mill, a vibration ball mill, a satellite ball mill, a planetary ball mill, a jet mill, a sieve, a centrifuge, or an air classifier.

The oxide material is manufactured by, for example, melting raw material powder under heating, thereby causing vitrification thereof. In particular, raw material powder including an oxide material comprising Sn is preferably melted in a reducing atmosphere or an inert atmosphere.

In the oxide material comprising Sn, the oxidation state of Sn atom is liable to change depending on melting conditions, and hence, when melting is carried out in an air atmosphere, an undesirable SnO₂ crystal, an undesirable SnP₂O₇ crystal, and the like are liable to be formed in the surface of a melt or in a melt. As a result, the initial charge-discharge efficiency and cycle performance of the resultant negative electrode material may deteriorate. Thus, when melting is carried out in a reducing atmosphere or an inert atmosphere, the increase of the valence of Sn ion in the negative-electrode active material can be suppressed, the formation of undesirable crystals can be suppressed, and consequently, an electricity storage device excellent in initial charge-discharge efficiency and cycle performance can be provided.

In order to carry out melting in a reducing atmosphere, it is preferred to supply a reducing gas into a melting tank. It is preferred to use, as the reducing gas, a mixed gas comprising, in terms of vol %, 90 to 99.5% of N₂ and 0.5 to 10% of H₂ and it is particularly preferred to use a mixed gas comprising 92 to 99% of N₂ and 1 to 8% of H₂.

When melting is carried out in an inert atmosphere, it is preferred to supply an inert gas into a melting tank. It is preferred to use, as the inert gas, any of nitrogen, argon, and helium.

The reducing gas or the inert gas may be supplied into the upper atmosphere of molten glass in a melting tank, or may be directly supplied into molten glass from a bubbling nozzle. Both methods may be carried out at the same time.

Further, in the method of manufacturing the oxide material described above, when a complex oxide is used as the starting raw material powder, it is easier to manufacture an oxide material which contains devitrified materials at a small ratio and is excellent in homogeneity. Using such the negative-electrode active material as a negative electrode material, an electricity storage device having a stable discharge capacity is easy to be obtained. Examples of such complex oxide include stannous pyrophosphate (Sn₂P₂O₇).

A negative-electrode active material may be predoped with lithium. With this, a negative electrode for an electricity storage device excellent in initial charge-discharge efficiency can be provided. A method for the predoping with lithium is not particularly limited. The predoping may be carried out electrochemically after manufacturing an electrode, or may be carried out by bringing a negative-electrode active material into direct contact with metal lithium in an organic solvent.

Note that, after an electricity storage device using the negative-electrode active material of the present invention is charged or discharged, or after the predoping with lithium is performed, the negative-electrode active material may contain a lithium oxide, Sn—Li alloy, metal tin, or an alloy formed of an inorganic material and Li.

The negative-electrode active material of the present invention comprises, in terms of mass %, preferably 10 to 95% of the oxide material and 5 to 90% of the inorganic material, 30 to 90% of the oxide material and 10 to 70% of the inorganic material, 50 to 90% of the oxide material and 10 to 50% of the inorganic material, particularly preferably 60 to 80% of the oxide material and 20 to 40% of the inorganic material.

When the negative-electrode active material comprises less than 10% of the oxide material (or more than 90% of the inorganic material), the volume change of the negative-electrode active material during charge and discharge is large, with the result that the capacity is liable to lower during repeated charge and discharge . On the other hand, when the negative-electrode active material comprises more than 95% of the oxide material (or less than 5% of the inorganic material), the initial charge-discharge efficiency tends to deteriorate.

The negative-electrode active material for an electricity storage device of the present invention may be in any form without particular limitations. The form thereof is preferably mixed powder comprising a powdered inorganic material and a powdered oxide material in view of easy handling. Further, it is possible to adopt a form in which an inorganic material is dispersed in an oxide material by heating the mixed powder to a temperature equal to or higher than the softening point of the oxide material. In addition, it is possible to adopt a form in which the surface of a powdered inorganic material is coated with an oxide material.

The mixed powder comprising a powdered inorganic material and a powdered oxide material may be manufactured by a general technique. Appropriate examples thereof include dry mixing using a ball mill, a tumbler mixer, a vibration mill, or a planetary ball mill and the like, wet mixing with adding an agent such as water or an alcohol, and wet mixing using, for example, a rotation-revolution mixer, a propeller stirrer, a bead mill, or a jet mill.

A negative electrode material for an electricity storage device of the present invention may be formed by adding a conductive agent and a binder to the above-mentioned negative-electrode active material for an electricity storage device.

The conductive agent is a component that is added in order to attain a higher capacity and a higher rate of the negative electrode material. Specific examples of the conductive agent include highly conductive carbon black such as acetylene black and ketjen black and metal powders such as a Ni powder, a Cu powder, and an Ag powder. Of those, it is preferred to use any one of the highly conductive carbon black, the Ni powder, and the Cu powder exerting excellent conductivity even when added in a very small amount.

The binder is a component that is added in order to bind materials constituting a negative electrode to each other, thereby preventing the negative-electrode active material from being detached from the negative electrode due to the volume change during charge and discharge. Specific examples of the binder include thermoplastic linear polymers such as styrene-butadiene rubber (SBR)of aqueous dispersion type, polyvinylidene fluoride (PVDF), and polytetrafluoroethylene (PTFE), and thermosetting resins such as thermosetting polyimide, a phenol resin, an epoxy resin, a urea resin, a melamine resin, an unsaturated polyester resin, and polyurethane. The thermosetting resins are particularly preferred because of being excellent in chemical resistance, heat resistance, crack resistance, and binding property.

The content of the negative-electrode active material in the negative electrode material of the present invention is, in terms of mass%, preferably 55 to 90%, 60 to 88%, 70 to 86%. When the content of the negative-electrode active material is less than 55%, the charge-discharge capacity per unit mass of the negative electrode material becomes smaller, resulting in difficulty in achieving a higher capacity. On the other hand, when the content of the negative-electrode active material is more than 90%, there is brought about such a state that the negative-electrode active material is densely filled in the negative electrode material, and hence gaps necessary for abating the volume change during charge and discharge cannot be secured sufficiently, and consequently, the cycle performance tends to deteriorate.

The content of the conductive agent in the negative electrode material of the present invention is, in terms of mass %, preferably 3 to 20%, 4 to 15%, particularly preferably 5 to 13%. When the content of the conductive agent is less than 3%, an electron-conducting network necessary for sufficiently covering the negative-electrode active material cannot be formed, resulting in the reduction of the capacity and the remarkable reduction of its high-rate performance. On the other hand, when the content of the conductive agent is more than 20%, the bulk density of the negative electrode material lowers, with the result that the charge-discharge capacity per unit volume of the negative electrode material lowers and that the strength of the negative electrode material also lowers.

The content of the binder in the negative electrode material of the present invention is, in terms of mass %, preferably 5 to 30%, 7 to 25%, 10 to 23%. When the content of the binder is less than 5%, the property of binding a negative-electrode active material and a conductive agent is poorly exhibited, and hence the negative-electrode active material is liable to be detached from the negative electrode material due to the volume change during repeated charge and discharge, and consequently, the cycle performance tends to lower. On the other hand, when the content of the binder is more than 30%, the binder is liable to interpose between the negative-electrode active material and the conductive agent or between the conductive agent in the negative electrode material, and hence the electron-conducting network is divided, with the result that a higher capacity is not achieved and that the high-rate performance tends to deteriorate remarkably.

The negative electrode material of the present invention may be, for example, a paste state in which the negative electrode material is dispersed in water or an organic solvent such as N-methylpyrrolidone and homogeneously mixed.

When the negative electrode material for an electricity storage device of the present invention is coated on a surface of a metal foil and the like serving as a current collector, the resultant can be used as a negative electrode for an electricity storage device . The thickness of the negative electrode material may be suitably adjusted depending on targeted capacities, and the thickness is, for example, preferably 1 to 250 μm, 2 to 200 μm, particularly preferably 3 to 150 μm. If the thickness of the negative electrode material is more than 250 μm, when the resultant negative electrode is used in a folded state in a battery, a tensile stress is liable to be generated in the surface of the negative electrode material. Thus, a crack is liable to be generated due to the volume change of the negative-electrode active material during repeated charge and discharge, and consequently, the cycle performance tends to deteriorate remarkably. On the other hand, if the thickness of the negative electrode material is less than 1 μm, there occurs a portion partially at which the binder cannot cover the negative-electrode active material, and consequently, the cycle performance tends to deteriorate.

The negative electrode for an electricity storage device of the present invention can be obtained by coating a surface of a current collector with the negative electrode material, followed by drying. Any method for drying may be used without particular limitations, but drying can be preferably performed by heat treatment under a reduced pressure, under an inert atmosphere, or under a reducing atmosphere at preferably 100 to 400° C., 120 to 380° C., particularly preferably 140 to 360° C. When the temperature of the heat treatment is less than 100° C., water adsorbing to the negative electrode material is not sufficiently removed. As a result, the remaining water decomposes in an electricity storage device, thereby oxygen is released, causing explosion, or the remaining water reacts with lithium, occurring an ignition due to heat generation. Therefore, the electricity storage device may become lacked safety. On the other hand, if the temperature of heat treatment is more than 400° C., the binder and materials constituting the negative electrode are liable to be decomposed. As a result, there occurs a portion partially at which the binder cannot cover the negative-electrode active material, or the binding property becomes lowered due to decomposition of the binder, and consequently, the cycle performance tends to deteriorate.

In the foregoing, description has been made mainly of a negative electrode material for a lithium ion secondary battery. However, the negative-electrode active material, the negative electrode material and negative electrode each using the negative-electrode active material of the present invention are not limited thereto, and can also be applied to other non-aqueous secondary batteries, a hybrid capacitor in which a negative electrode material for a lithium ion secondary battery and a positive electrode material for a non-aqueous electric double layer capacitor are combined, and the like.

A lithium ion capacitor, which is a hybrid capacitor, is a kind of asymmetric capacitor, in which the charge-discharge principle of a positive electrode and that of a negative electrode are different. The lithium ion capacitor has a structure in which a negative electrode for a lithium ion secondary battery and a positive electrode for an electric double layer capacitor are combined. Here, the positive electrode is charged and discharged through a physical action (static electricity action) of an electric double layer formed on its surface, whereas the negative electrode is charged and discharged through chemical reactions (storage and release) of Li ions, in the same manner as in a lithium ion secondary battery described previously.

There is used, for the positive electrode of the lithium ion capacitor, a positive electrode material formed of, for example, carbonaceous powder having a high specific surface area, such as powder of activated carbon, a polyacene, or mesophase carbon. On the other hand, it can be used, for the negative electrode, a material in which Li ions and electrons are stored in the negative-electrode active material of the present invention.

There is no particular limitation to means for storing Li ions and electrons in the negative-electrode active material of the present invention. For example, it is possible that a metal Li electrode serving as supply sources of Li ions and electrons is provided in a capacitor cell and is brought into contact with a negative electrode comprising the negative electrode material of the present invention directly or through an electric conductor, or it is possible that Li ions and electrons are preliminarily stored in the negative electrode material of the present invention in another cell and such the cell is installed in a capacitor cell.

### EXAMPLES

Hereinafter, as an example of the negative electrode material for an electricity storage device of the present invention, a negative electrode material for a non-aqueous secondary battery is described in detail by way of examples, but the present invention is not limited to these examples.

Tables 1 to 3 show Examples 1 to 16 and Comparative Examples 1 to 8.

(1) Preparation of Negative-Electrode Active Material for Non-Aqueous Secondary Battery

Raw material powder for an oxide material in a negative-electrode active material was prepared by using a complex oxide of tin and phosphorus (stannous pyrophosphate: Sn₂P₂O₇) as the main raw material together with various oxides, a carbonate raw material, and the like, so that each composition shown in Tables 1 and 2 was attained. The raw material powder was fed into a quartz crucible and was melted in a nitrogen atmosphere at 950° C. for 40 minutes by using an electric furnace, causing vitrification thereof.

Next, the molten glass was poured between a pair of rotating rollers and was formed into a film-shaped glass having a thickness of 0.1 to 2 mm while being quenched. The film-shaped glass was fed into a ball mill containing zirconia balls with diameters of 2 to 3 cm and was pulverized at 100 rpm for 3 hours . The pulverized glass was then passed through a resin sieve having a mesh size of 120 μm, obtaining glass coarse powder having the average particle diameter of 8 to 15 μm. Subsequently, the glass coarse powder was subjected to air classification, obtaining glass powder (oxide material powder) having the average particle diameter of 3 μm and the maximum particle diameter of 38 μm.

Each oxide material powder was subjected to powder X-ray diffraction measurement to identify its structure. The oxides of Examples 1 to 13 and 16 and Comparative Examples 5 to 8 were amorphous and no crystal was detected. The oxides of Examples 14 and 15 were mostly amorphous, but a crystal was partially detected.

In Examples 1 to 16, each inorganic material powder shown in Tables 1 and 2 was mixed with each of the resulting oxide materials at each ratio shown in the tables, and the each mixture was fed into a nitrogen-sealed container and was further mixed by using a ball mill, obtaining each negative-electrode active material.

Note that each inorganic material powder shown in Tables 1 to 3 has the average particle diameter and the maximum particle diameter as follows. Namely, Si powder has the average particle diameter of 2.1 μm and the maximum particle diameter of 8.9 μm, Sn powder has the average particle diameter of 2.5 μm and the maximum particle diameter of 12.6 μm, Al powder has the average particle diameter of 2.2 μm and the maximum particle diameter of 9.2 μm, and graphite powder has the average particle diameter of 20 μm and the maximum particle diameter of 155 μm.

(2) Preparation of Negative Electrode for Non-Aqueous Secondary Battery

Each negative-electrode active material obtained above, a conductive agent, and a binder were weighed so as to achieve a ratio of 80:5:15 (mass %) , and were dispersed in N-methylpyrrolidone (NMP), followed by sufficient stirring with a rotation-revolution mixer, yielding a slurry. Here, ketjen black (hereinafter, abbreviated as “KB”) was used as the conductive agent and a polyimide resin (hereinafter, abbreviated as “PI”) was used as the binder.

Next, a doctor blade with a gap of 150 μm was used to coat a copper foil having a thickness of 20 μm and serving as a negative electrode current collector with the resultant slurry, and the coated copper foil was dried at 70° C. with a dryer and was then passed through and pressed between a pair of rotating rollers, obtaining an electrode sheet. An electrode punching machine was used to punch a piece having a diameter of 11 mm out of the electrode sheet, and the piece was dried and simultaneously cured (imidized) at a thermal curing temperature of 250° C. for 3 hours under a reducing atmosphere of nitrogen/hydrogen (98 vol %/2 vol %), obtaining a circular working electrode (negative electrode for a non-aqueous secondary battery).

(3) Preparation of Test Battery

The working electrode was placed with its copper foil surface facing downward on a lower lid of a coin cell, and there were laminated, on the working electrode, a separator formed of a polypropylene porous film (Celgard #2400 manufactured by Hoechst Celanese Corporation) having a diameter of 16 mm, which had been dried under reduced pressure at 60° C. for 8 hours, and metal lithium serving as an opposite electrode, thus preparing a test battery. Used as an electrolytic solution was a 1 M LiPF₆ solution/EC:DEC=1:1 (EC=ethylene carbonate, DEC=diethyl carbonate). Note that the assembly of the test battery was carried out in an environment of a dew-point temperature of −60° C. or less.

(4) Charge-Discharge Test

Charge (storage of Li ions in a negative-electrode active material) was carried out by 0.2 mA constant current (CC) charge from 2 V to 0 V. Next, discharge (release of Li ions from the negative-electrode active material) was carried out by discharge at a constant current of 0.2 mA from 0 V to 2 V. This charge-discharge cycle was repeated.

Tables 1 to 3 show the results of initial charge-discharge performance in the charge-discharge test and the results of cycle performances when repeated charge and discharge was carried out, with respect to the batteries using the negative-electrode active materials of the examples and comparative examples.

TABLE 1

| | | | | Example | | | | | | | |
|---|---|---|---|---|---|---|---|---|---|---|---|
| | | | | 1 | 2 | 3 | 4 | 5 | 6 | 7 | 8 |
| Negative- | Inorganic material | | | Si | Sn | Si | Si | Si | Sn | Al | Graphite |
| electrode | Oxide | Composition | SnO | 68 | 68 | 71 | 71 | 71 | 71 | 71 | 71 |
| active | material | (mol %) | P₂O₅ | 32 | 32 | 29 | 29 | 29 | 29 | 29 | 29 |
| material | | | Al₂O₃ | | | | | | | | |
| | | | B₂O₃ | | | | | | | | |
| | | | MgO | | | | | | | | |
| | | | SnO/P₂O₅ | 2.1 | 2.1 | 2.4 | 2.4 | 2.4 | 2.4 | 2.4 | 2.4 |

| | | | | | | | | |
|---|---|---|---|---|---|---|---|---|
| Precipitated crystal | Absent | Absent | Absent | Absent | Absent | Absent | Absent | Absent |
| (Crystallinity (%)) | | | | | | | | |

| | | | | | | | | | |
|---|---|---|---|---|---|---|---|---|---|
| Composition (mass %) of | Inorganic | 40 | 40 | 50 | 30 | 10 | 30 | 30 | 60 |
| negative-electrode | material | | | | | | | | |
| active material | Oxide | 60 | 60 | 50 | 70 | 90 | 70 | 70 | 40 |
| | material | | | | | | | | |
| Charge-discharge | Initial | 2141 | 1157 | 2354 | 1915 | 1476 | 1177 | 1162 | 746 |
| performance | charge | | | | | | | | |
| | capacity | | | | | | | | |
| | (mAh/g) | | | | | | | | |
| | Initial | 1725 | 841 | 1976 | 1486 | 997 | 823 | 808 | 524 |
| | discharge | | | | | | | | |
| | capacity | | | | | | | | |
| | (mAh/g) | | | | | | | | |
| | Initial | 80.5 | 72.6 | 84.0 | 77.6 | 67.5 | 70.0 | 69.6 | 70.2 |
| | charge- | | | | | | | | |
| | discharge | | | | | | | | |
| | efficiency | | | | | | | | |
| | (%) | | | | | | | | |
| | Discharge | 1302 | 613 | 1328 | 1134 | 820 | 647 | 635 | 515 |
| | capacity at | | | | | | | | |
| | 50th cycle | | | | | | | | |
| | (mAh/g) | | | | | | | | |

TABLE 2

| | | | | Example | | | | | | | |
|---|---|---|---|---|---|---|---|---|---|---|---|
| | | | | 9 | 10 | 11 | 12 | 13 | 14 | 15 | 16 |
| Negative- | Inorganic material | | | Si | Si | Si | Si | Sn | Si | Sn | Si |
| electrode | Oxide | Composition | SnO | 76 | 76 | 76 | 81 | 81 | 86 | 86 | 68 |
| active | material | (mol %) | P₂O₅ | 24 | 24 | 24 | 19 | 19 | 14 | 14 | 22.5 |
| material | | | Al₂O₃ | | | | | | | | 1 |
| | | | B₂O₃ | | | | | | | | 7 |
| | | | MgO | | | | | | | | 1.5 |
| | | | SnO/P₂O₅ | 3.2 | 3.2 | 3.2 | 4.3 | 4.3 | 6.1 | 6.1 | 3.0 |

| | | | | | | | | |
|---|---|---|---|---|---|---|---|---|
| Precipitated crystal | Absent | Absent | Absent | Absent | Absent | SnO₂ (4) | SnO₂ (4) | Absent |
| (Crystallinity (%)) | | | | | | | | |

| | | | | | | | | | |
|---|---|---|---|---|---|---|---|---|---|
| Composition (mass %) of | Inorganic | 50 | 30 | 10 | 10 | 30 | 10 | 30 | 50 |
| negative-electrode | material | | | | | | | | |
| active material | Oxide | 50 | 70 | 90 | 90 | 70 | 90 | 70 | 50 |
| | material | | | | | | | | |
| Charge-discharge | Initial | 2362 | 1927 | 1492 | 1629 | 1296 | 1583 | 1260 | 2292 |
| performance | charge | | | | | | | | |
| | capacity | | | | | | | | |
| | (mAh/g) | | | | | | | | |
| | Initial | 1981 | 1493 | 1006 | 1119 | 919 | 1144 | 938 | 1946 |
| | discharge | | | | | | | | |
| | capacity | | | | | | | | |
| | (mAh/g) | | | | | | | | |
| | Initial | 83.9 | 77.5 | 67.4 | 68.7 | 70.9 | 72.3 | 74.5 | 84.9 |
| | charge- | | | | | | | | |
| | discharge | | | | | | | | |
| | efficiency | | | | | | | | |
| | (%) | | | | | | | | |
| | Discharge | 1173 | 970 | 623 | 623 | 520 | 585 | 503 | 1223 |
| | capacity at | | | | | | | | |
| | 50th cycle | | | | | | | | |
| | (mAh/g) | | | | | | | | |

TABLE 3

| | | | | Comparative Example | | | | | | | |
|---|---|---|---|---|---|---|---|---|---|---|---|
| | | | | 1 | 2 | 3 | 4 | 5 | 6 | 7 | 8 |
| Negative- | Inorganic material | | | Si | Sn | Al | Graphite | | | | |
| electrode | Oxide | Composition | SnO | | | | | 68 | 71 | 76 | 81 |
| active | material | (mol %) | P₂O₅ | | | | | 32 | 29 | 24 | 19 |
| material | | | Al₂O₃ | | | | | | | | |
| | | | B₂O₃ | | | | | | | | |
| | | | MgO | | | | | | | | |
| | | | SnO/P₂O₅ | | | | | 2.1 | 2.4 | 3.2 | 4.3 |

| | | | | |
|---|---|---|---|---|
| Precipitated crystal | Absent | Absent | Absent | Absent |
| (Crystallinity (%)) | | | | |

| | | | | | | | | | |
|---|---|---|---|---|---|---|---|---|---|
| Charge-discharge | Initial | 3430 | 998 | 975 | 485 | 1269 | 1257 | 1274 | 1427 |
| performance | charge | | | | | | | | |
| | capacity | | | | | | | | |
| | (mAh/g) | | | | | | | | |
| | Initial | 3180 | 930 | 870 | 372 | 741 | 752 | 762 | 888 |
| | discharge | | | | | | | | |
| | capacity | | | | | | | | |
| | (mAh/g) | | | | | | | | |
| | Initial | 92.7 | 93.2 | 89.2 | 76.7 | 58.4 | 59.8 | 59.8 | 62.2 |
| | charge- | | | | | | | | |
| | discharge | | | | | | | | |
| | efficiency | | | | | | | | |
| | (%) | | | | | | | | |
| | Discharge | 477 | 37 | 122 | 370 | 560 | 585 | 413 | 424 |
| | capacity at | | | | | | | | |
| | 50th cycle | | | | | | | | |
| | (mAh/g) | | | | | | | | |

The initial discharge capacity of the battery using the negative-electrode active material of each of Examples 1 to 16 was 524 mAh/g or more, the initial charge-discharge efficiency thereof was 67.4% or more, and the discharge capacity thereof at the 50th cycle was 503 mAh/g or more, showing good performance. On the other hand, the initial discharge capacity of the battery using the negative-electrode active material of each of Comparative Examples 1 to 3 was 870 mAh/g or more, and the initial charge-discharge efficiency thereof was as good as 89.2% or more, showing good performance, but the discharge capacity thereof at the 50th cycle was as remarkably low as 477 mAh/g or less. The initial discharge capacity of the battery using the negative-electrode active material of Comparative Example 4 was as low as 372 mAh/g. The initial discharge capacity of the battery using the negative-electrode active material of each of Comparative Examples 5 to 8 was 741 mAh/g or more, but the initial charge-discharge efficiency thereof was as low as 62.2% or less.

1. A negative-electrode active material for an electricity storage device, comprising:
at least one kind of inorganic material selected from Si, Sn, Al, an alloy comprising any one of Si, Sn, and Al, and graphite; and
an oxide material comprising at least one of P₂O₅ and B₂O₃.

2. The negative-electrode active material for an electricity storage device according to claim 1, wherein the oxide material further comprises SnO.

3. The negative-electrode active material for an electricity storage device according to claim 2, wherein the oxide material comprises, as a composition in terms of mol %, 45 to 95% of SnO and 5 to 55% of P₂O₅.

4. The negative-electrode active material for an electricity storage device according to claim 3, wherein the oxide material is substantially amorphous.

5. The negative-electrode active material for an electricity storage device according to claim 1, wherein a content of the inorganic material is 5 to 90% and a content of the oxide material is 10 to 95% in terms of mass %.

6. A negative electrode material for an electricity storage device, comprising the negative-electrode active material for an electricity storage device according to claim 1, a conductive agent, and a binder.

7. The negative electrode material for an electricity storage device according to claim 6, wherein a content of the negative-electrode active material is 55 to 90%, a content of the binder is 5 to 30%, and a content of the conductive agent is 3 to 20% in terms of mass %.

8. A negative electrode for an electricity storage device, comprising a current collector having a surface coated with the negative electrode material for an electricity storage device according to claim 6.
